(19) United States
(12) Patent Application Publication
(10) Pub. No.: US 2008/0185508 A1
(43) Pub. Date: Aug. 7, 2008

(54) Packaging module of optical sensor

(75) Inventors: Chia-Chu Cheng, Hsin-Tien City (TW); Ya-Lun Lee, Hsin-Tien City (TW); Yu-Wei Lu, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORPORATION

(21) Appl. No.: 11/703,185

(22) Filed: Feb. 7, 2007

(51) Int. Cl. H01J 5/02; H01J 40/14

(52) U.S. Cl. 250/239

(57) ABSTRACT

An improved packaging module of an optical sensor includes a circuit board and an optical sensor module. The optical sensor module comprises a linear optical sensor, and an illuminating unit respectively electronically connected with the circuit board, and a second protective body packaging the linear optical sensor and the illuminating unit. A first protective body covers the linear optical sensor and illuminating unit, the second protective body defines a first aperture corresponding to the linear optical sensor and a second aperture corresponding to the illuminating unit. A first light pipe set at the first aperture and a second light pipe set at the second aperture, the linear optical sensor, illuminating unit, first protective body and second protective body are combined integrally, which makes the packaging module process simple, adjustment of the optical sensor module's components achieved automatically, and the space of the optical sensor is reduced.

### BACKGROUND OF THE INVENTION

1. Field of the Invention

The present invention relates to an improved packaging module of an optical sensor, and more specifically to an improved packaging module of an optical sensor used in a mouse and packaged with a linear optical sensor, an illuminating unit, a first protective body and a second protective body, the components are combined integrally.

2. Description of the Prior Art

Referring to FIG. 1, a packaging module of an optical sensor of a first prior art is shown, the module includes a circuit board 1a, a illuminating component 2a, an illuminating source fixing structure 3a, an optical sensor 4a, a packaging cover 5a and an imaging lens 6a.

The illuminating component 2a is fixed on the illuminating source fixing structure 3a and is connected electronically with the circuit board 1a by a conducting wire 20a. The optical sensor 4a is mounted on the circuit board 1a and is connected electronically with the circuit board 1a by two conducting wires 40a. The packaging cover 5a is used for packaging the optical sensor 4a and defines an aperture 50a. The imaging lens 6a is set on the packaging cover 5a corresponding to the aperture 50a and the optical sensor 4a.

The illuminating component 2a shines a beam of light L1 onto a piece of paper D, the beam of light L1 is scattered to form scattered light L2, the scattering light L2 penetrates the aperture 50a and the imaging lens 6a and is then shot at the optical sensor 4a. The paper D is sensed by the optical sensor 4a.

However, the optical sensor 4a, the packaging cover 5a and the imaging lens 6a are discrete in form, for assembling and process. The optical sensor 4a, the packaging cover 5a and the imaging lens 6a must be adjusted to cooperate at a certain specific optical angle, thus, the scattering light L2 can be shone onto the optical sensor 4a, and because the illuminating source fixing structure 3a and the optical sensor 4a are discrete components, the positions of the illuminating component 2a and the optical sensor 4a need to be adjusted accurately to make the optical sensor 4a sense the scattering light L2. Moreover, because the illuminating source fixing structure 3a and the packaging cover 5a are discrete components, the costs of the material are high.

Referring to FIG. 2A, a packaging module for an optical sensor of a second prior art is shown, the packaging module of the optical sensor includes a body 1b, an LED (light-emitting diode) unit 2b, a sensor unit 3b, an optical unit 4b and a control unit 5b. The body 1b includes a holding space 11b, a lead portion 12b contained in the holding space 11b, a plurality of pins 13b connected with the body 1b and a cover 14b set on a bottom of the body 1b. The LED unit 2b includes at least one LED and is contained in the holding space 11b to connect electronically with the lead portion 12b. The sensor unit 3b is a sensor and is contained in the holding space 11b to connect electronically with the lead portion 12b. The optical unit 4b is set on the cover 14b and includes a first optical component 41b and a second optical component 42b. The second optical component 42b corresponds to the sensor unit 3b, and the first optical component 41b and the second optical component 42b are combined integrally on the cover 14b respectively. The control unit 5b is a control chip and is contained in the holding space 11b to connect electronically with the lead portion 12b. The body 1b, the LED unit 2b, the sensor unit 3b, the optical unit 4b and the control unit 5b are packaged as a whole.

Referring to FIG. 2B, an optical sensor module of a prior art assembled in a mouse is shown. The module is packaged by the method of DIP (Dual In-line Package) and is mounted on a circuit board 61b of an optical mouse 6b. The optical mouse 6b includes a shell 62b and a mouse base 63b, the mouse base 63b defines a penetrating hole 631b thereon. The LED unit 2b and the sensor unit 3b of the optical sensor module correspond to the penetrating hole 631b.

Light shone from the LED unit 2b penetrates the first optical component 41b and scatters onto a plane. Next, the light is reflected to the second optical component 42b by the plane. Finally, the light penetrates the second optical component 42b and is received by the sensor unit 3b.

The shortcomings of the packaging module of the optical sensor of prior arts are:

1. The optical sensor 4a, the packaging cover 5a and the imaging lens 6a are discrete in form, thereby, the process is complicated, assembling is difficult, and adjustment of positions is difficult.
2. Package volume of the packaging cover 5a of the optical sensor 4a is large so that space taken up is also large. Therefore, the packaging module is large, which wastes a lot of space.
3. A large amount of material is used for the packaging module so costs are high.
4. The first optical component 41b and the second optical component 42b of the optical unit 4b and the cover 14b are assembled by a combining technique, so the process and structure are complicated and difficult.

Hence, the inventors of the present invention believe that these shortcomings above are able to be improved upon and suggest the present invention which is of a reasonable design and is an effective improvement based on deep research and thought.

### SUMMARY OF THE INVENTION

An object of the present invention is to provide an improved packaging module of an optical sensor. The linear optical sensor, the illuminating unit, the first protective body and the second protective body are combined integrally, making the process of the packaging module easy, adjustment of the components of the optical sensor module can be achieved automatically in the assembly process, space taken up by the packaging module of the optical sensor is reduced, and thus, the volume of the packaging module is small.

To achieve the above-mentioned objects, an improved packaging module of an optical sensor is disclosed. The module comprises a circuit board and an optical sensor module mounted on the circuit board. The optical sensor module comprises a linear optical sensor connected electronically with the circuit board, an illuminating unit connected electronically with the circuit board, and a second protective body packaging the linear optical sensor. A first protective body covers the linear optical sensor and the illuminating unit. The second protective body defines a first aperture thereon corresponding to the linear optical sensor.

Furthermore, the first protective body defines a first light pipe set at the first aperture, and the first light pipe and the first protective body are formed integrally.

The linear optical sensor, the illuminating unit, the first protective body and the second protective body of the optical sensor module are combined integrally, which makes the process of the packaging module easy, adjustment of components of the optical sensor module is achieved automatically during the assembly process, space taken up by the packaging module of the optical sensor is reduced, and thus, the volume of the packaging module is smaller.

To achieve the above-mentioned objects, another improved packaging module of an optical sensor is disclosed. The module comprises a circuit board and an optical sensor module mounted on the circuit board. The optical sensor module comprises a linear optical sensor connected electronically with the circuit board, an illuminating unit connected electronically with the circuit board, and a second protective body packaging the linear optical sensor. A first protective body covers the linear optical sensor and the illuminating unit, the second protective body defines a first aperture thereon corresponding to the linear optical sensor and a second aperture thereon corresponding to the illuminating unit.

Furthermore, the first protective body defines a first light pipe set at the first aperture and a second light pipe set at the second aperture. The first light pipe and the second light pipe are formed integrally on the first protective body.

The linear optical sensor, the illuminating unit, the first protective body and the second protective body of the optical sensor module are combined integrally. This makes the processing of the packaging module easy, adjustment of components of the optical sensor module can be achieved automatically during the assembly process, and space taken up by the packaging module of the optical sensor is reduced. Thus, the volume of the packaging module is reduced.

To further understand the features and technical contents of the present invention, please refer to the following detailed description and drawings related to the present invention. However, the drawings are only to be used as references and explanations, and not to limit the present invention.

### BRIEF DESCRIPTION OF THE DRAWINGS

FIG. 1 is an isometric view of a packaging module of an optical sensor of a first prior art;

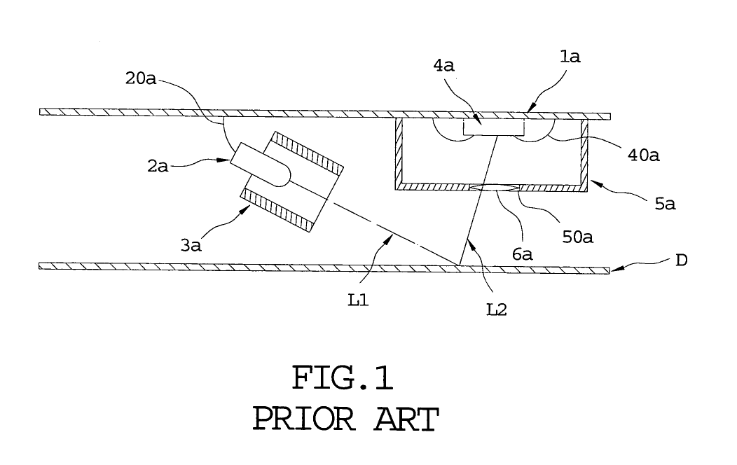

FIG. 2A is an isometric view of a packaging module of an optical sensor of a second prior art;

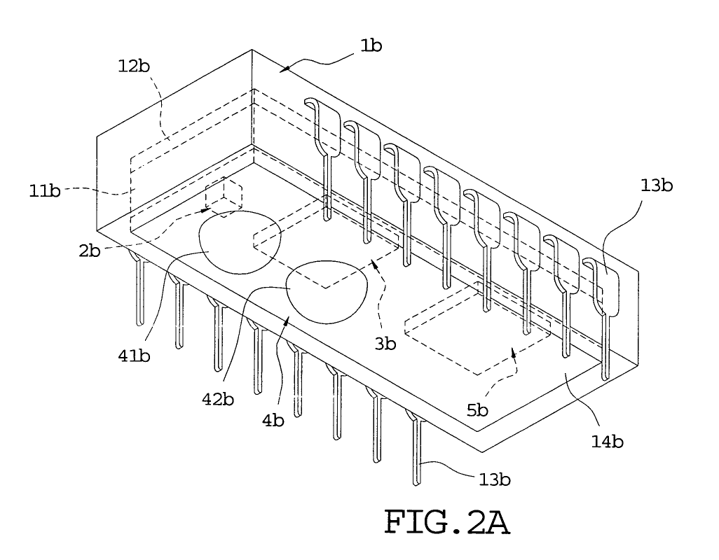

FIG. 2B is an isometric view of the optical sensor module assembled in a mouse of FIG. 2A;

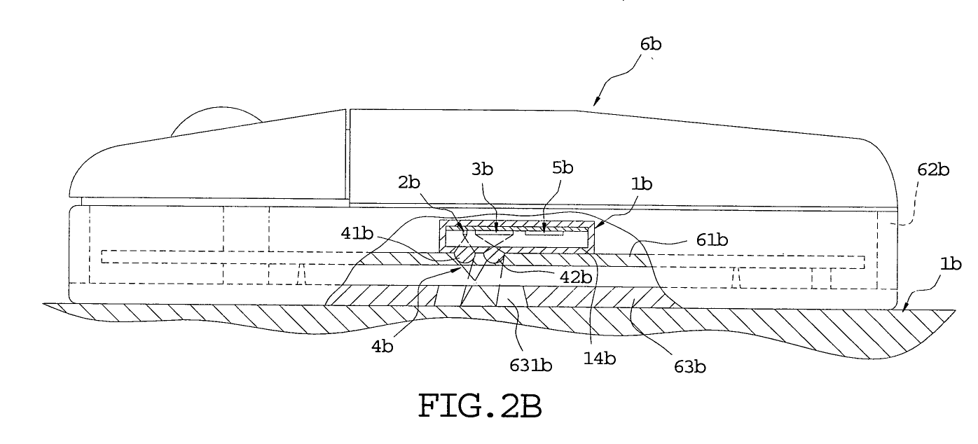

FIG. 3 is an isometric view of an improved packaging module of an optical sensor of a first embodiment of the present invention;

FIG. 4 is an isometric view of an improved packaging module of an optical sensor of a second embodiment of the present invention;

FIG. 5 is an isometric view of an improved packaging module of an optical sensor of a third embodiment of the present invention;

FIG. 6 is an isometric view of an improved packaging module of an optical sensor of a forth embodiment of the present invention;

FIG. 7 is an isometric view of an improved packaging module of an optical sensor of a fifth embodiment of the present invention;

FIG. 8 is an isometric view of an improved packaging module of an optical sensor assembled in a mouse of the present invention.

### DETAILED DESCRIPTION OF THE INVENTION

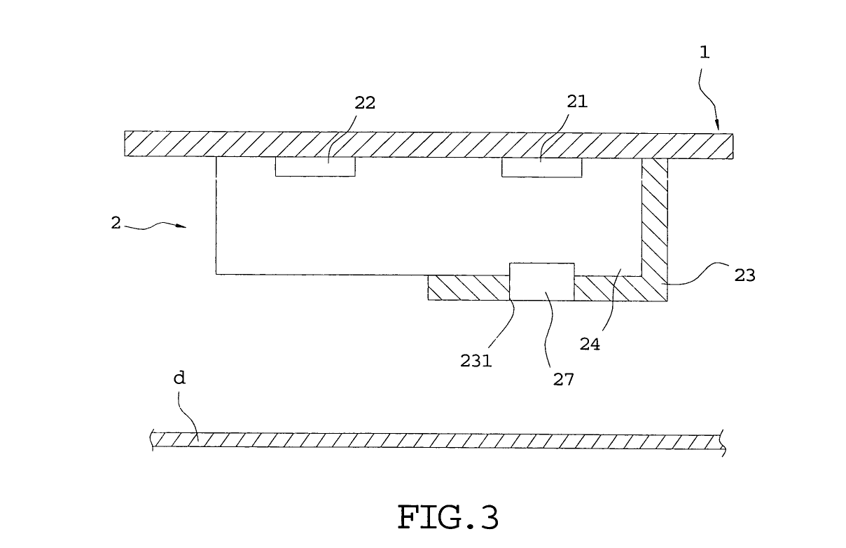

Referring to FIG. 3, an isometric view of an improved packaging module of an optical sensor of a first embodiment of the present invention is shown. The module includes a circuit board 1 and an optical sensor module 2.

The optical sensor module 2 is mounted on the circuit board 1 and includes a linear optical sensor 21 and an illuminating unit 22 connected electronically with the circuit board 1, and a second protective body 23 packaging the linear optical sensor 21. A first protective body 24 covers the linear optical sensor 21 and the illuminating unit 22. The second protective body 23 defines a first aperture 231 thereon corresponding to the linear optical sensor 21.

For the embodiment, the first protective body 24 includes a first light pipe 27 set at the first aperture 231 corresponding to the linear optical sensor 21. The first light pipe 27 and the first protective body 24 are formed integrally.

Thereby, the linear optical sensor 21, the illuminating unit 22, the second protective body 23 and the first protective body 24 are assembled via a combining technique, which simplifies the assembly process of the present invention. The components of the sensor module can be adjusted automatically, the amount of space required for the packaging module of the sensor is reduced, and thereby, the volume of the whole packaging module is reduced.

For the present invention, the illuminating unit 22 is an illuminating source, or, is an illuminating module assembled with an illuminating source and a lighting lens, or, is an LED or a laser source, and provides light to the linear optical sensor 21. The second protective body 23 is black or made of opaque plastic so as to ensure that the linear optical sensor 21 avoids unnecessary contact with light which may result in negative effects. The plastic may be Epoxy or Polycarb, and the first protective body 24 may be made of transparent material or transparent plastic which prevents the linear optical sensor 21 from directly contacting impurities, in which such contact may cause malfunctions. Moreover, the first protective body 24 may be made of Epoxy or Polycarb or IR Pass material.

The illuminating unit 22 shines a beam of light onto a file d, the light is then refracted by the file d to scatter the light, the scattered light is then shone onto the linear optical sensor 21 to enhance effects.

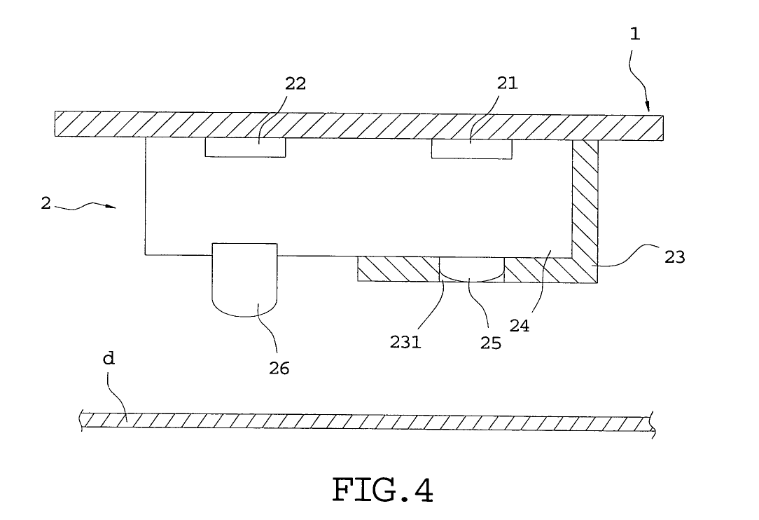

Referring to FIG. 4, an isometric view of an improved packaging module of an optical sensor of a second embodiment of the present invention is shown. The second embodiment differs from the first embodiment in that an imaging lens 25 of the second embodiment is set at the first aperture 231 of the second protective body 23 to replace the first light pipe 27 (shown in FIG. 3). The imaging lens 25 and the first protective body 24 are formed integrally. Furthermore, in the present embodiment, the packaging module further includes a lighting lens 26 corresponding to the illuminating unit 22. The lighting lens 26 and the first protective body 24 are formed integrally. Thus, the illuminating unit 22 shines a beam of equal congregating light onto the file d by passing through the lighting lens 26, then, the light is scattered by the file d to form scattered light, the scattered light is shone onto the linear optical sensor 21 by congregating of the imaging lens 25 of the first aperture 231 to be sensed. Users can set the imaging lens 25 according to their needs.

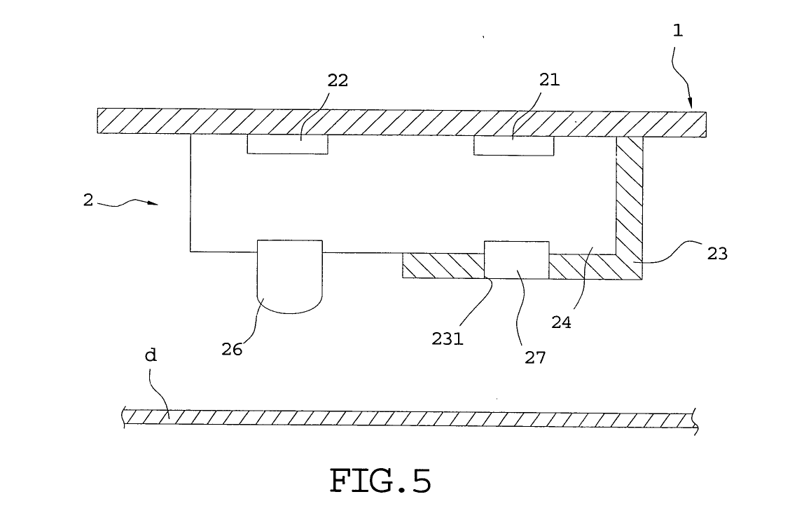

Referring to FIG. 5, an isometric view of an improved packaging module of an optical sensor of a third embodiment of the present invention is shown. The thirds embodiment differs to the first embodiment in that the packaging module of the third embodiment further includes a lighting lens 26 corresponding to the illuminating unit 22. The lighting lens 26 and the first protective body 24 are formed together, thus, the illuminating unit 22 shines a beam of equal congregating light onto the file d by passing through the lighting lens 26, then, the light is scattered by the file d to form scattered light. The scattered light is then shone onto the linear optical sensor 21 by congregating of the first light pipe 27 to be sensed. Users can set the lighting lens 26 according to their needs.

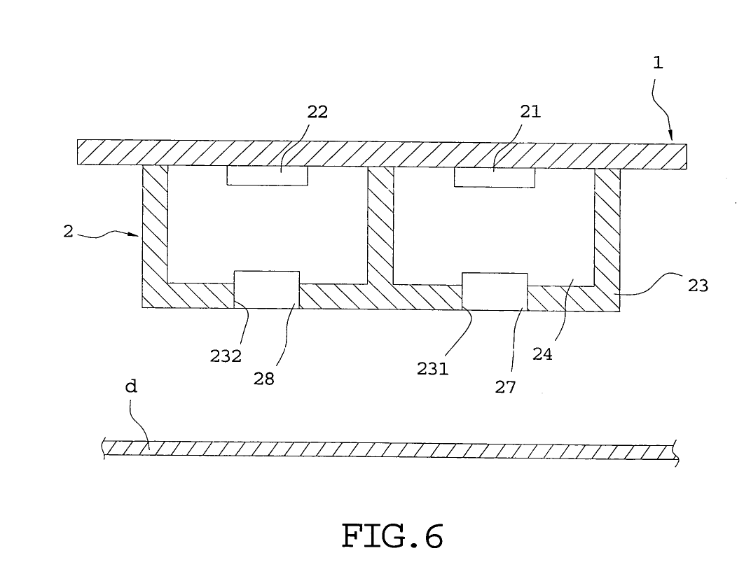

Referring to FIG. 6, an isometric view of an improved packaging module of an optical sensor of a forth embodiment of the present invention is shown. The forth embodiment differs from the first embodiment in that the second protective body 23 of the forth embodiment further packages the illuminating unit 22 other than packaging the linear optical sensor 21. The second protective body 23 defines a second aperture 232 thereon corresponding to the illuminating unit 22. Additional to the first light pipe 27, which is formed integrally with the first protective body 24 is set at the first aperture 231, a second light pipe 28 is set at the second aperture 232. The second light pipe 28 is also formed integrally with the first protective body 24. Thus, the efficacy of the embodiment is the same as that of the first, the second and the third embodiments.

Because the linear optical sensor 21, the illuminating unit 22, the first protective body 24, the second protective body 23, the first light pipe 27 and the second light pipe 28 are combined integrally, the linear optical sensor 21, the illuminating unit 22, the first light pipe 27 and the second light pipe 28 can be fixed on accurate optical positions. As such, the complicated and precise optical adjustments necessary in the prior art can be omitted, and the complicated processes and errors that occurred during the prior art assembly process can be avoided.

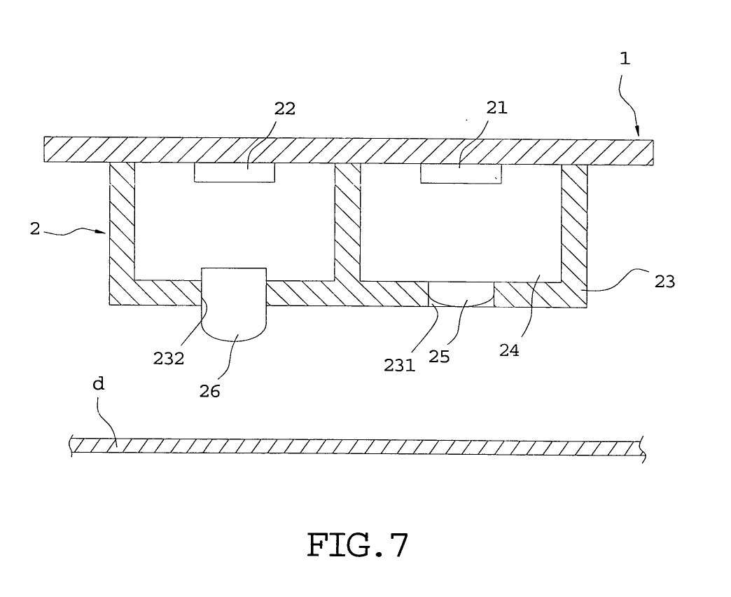

Referring to FIG. 7, an isometric view of an improved packaging module of an optical sensor of a fifth embodiment of the present invention is shown. The fifth embodiment differs from the first embodiment in that the second protective body 23 of the fifth embodiment further packages the illuminating unit 22. A second aperture 232 is defined on the second protective body 23 corresponding to the illuminating unit 22. The imaging lens 25 and the lighting lens 26 are set at the first aperture 231 and the second aperture 232 respectively, and the imaging lens 25 and the lighting lens 26 are formed integrally with the first protective body 24. Thus, the efficacy of the embodiment is the same as that of the first and the third embodiments.

For the present invention, the imaging lens 25 is a spherical lens or a non-spherical lens which reduces lens aberrations. Also, the lens is lightened and thinned. Similarly, the lighting lens 26 has a spherical lens or a non-spherical lens to guide light. The illuminating unit 22 can be an incoherent illuminator or a coherent illuminator. The linear optical sensor 21 can offer good sensory effects due to the performance of factual intervention of the coherent illuminant. Alternatively, the illuminating unit 22 cooperates with the lighting lens 26 and uses the condensation and light guiding performance of the lighting lens 26 to enhance illumination. Thus, the linear optical sensor 21 has better sensory effects.

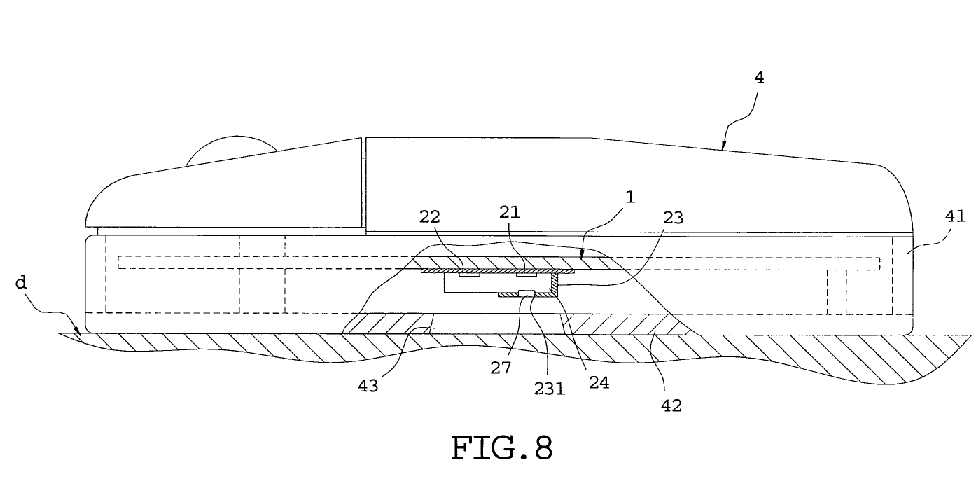

Referring to FIG. 8, an improved packaging module of an optical sensor assembled in a mouse of the present invention is shown. The packaging module of the optical sensor is packaged via SMT (Surface Mount Technology) technique and is set in a mouse 4 (or other sensor device). The mouse 4 includes a shell 41 and a mouse base 42. A penetrating hole 43 is defined on the mouse base 42.

For the improved packaging module of the optical sensor assembled in the mouse 4, it is the first embodiment which is assembled in the mouse 4. The linear optical sensor 21, the illuminating unit 22, the first protective body 24 and the second protective body 23 are combined integrally and correspond to the penetrating hole 43.

The illuminating unit 22 shines a beam of equal congregating light onto the file d by passing through the first protective body 24. Next, the light is scattered by the file d to form scattered light. The scattered light is shone onto the linear optical sensor 21 by the first aperture 231 of the first light pipe 27 to be sensed.

Also, other embodiments of the present invention can be applied in the mouse 4, and their efficacy is the same as that of the first embodiment.

In summary, the linear optical sensor, the illuminating unit, the first protective body and the second protective body of the present invention are combined integrally, which gives the present invention the following advantages:

1. The structure and process of the packaging module are all simple because the components of the module are combined integrally.
2. Adjustment is automatic during the assembly process because components of the module are combined integrally, and additional adjustment is unnecessary.
3. Cost of materials is low and the volume of the packaging module is reduced because the components of the module are combined integrally.
4. The first protective body is set upon the linear optical sensor and the illuminating unit, which ensures that the linear optical sensor and the illuminating unit avoid contact with impurities in the air that may shorten the life-span of the module.
5. Because the linear optical sensor, the illuminating unit, the imaging lens, the lighting lens, the first light pipe and the second light pipe are combined integrally, the components can be fixed on accurate optical positions, so unnecessary errors in the assembly process are avoided.
6. The imaging lens, the lighting lens, the first light pipe and the second light pipe can be assembled according to a user's requirements.

What is disclosed above are only the preferred embodiments of the present invention, and therefore it is intended that the present invention not be limited to the particular embodiment disclosed. It should be understood by those skilled in the art that various equivalent changes may be made depending on the specification and the drawings of present invention without departing from the scope of the present invention.

What is claimed is:

1. An improved packaging module of an optical sensor, comprising:
a circuit board, and
an optical sensor module, mounted on the circuit board and comprising a linear optical sensor connected electronically with the circuit board, an illuminating unit connected electronically with the circuit board, and a second protective body packaging the linear optical sensor, a first protective body covering the linear optical sensor and the illuminating unit, the second protective body defining a first aperture thereon corresponding to the linear optical sensor;
the linear optical sensor, the illuminating unit, the first protective body and the second protective body are combined integrally.

2. The improved packaging module of the optical sensor as claimed in claim 1, wherein a first light pipe is set at the first aperture corresponding to the linear optical sensor, and the first light pipe and the first protective body are formed integrally.

3. The improved packaging module of the optical sensor as claimed in claim 1, wherein an imaging lens is set at the first aperture corresponding to the linear optical sensor, and the imaging lens and the first protective body are formed integrally.

4. The improved packaging module of the optical sensor as claimed in claim 1, wherein a lighting lens is set corresponding to the illuminating unit, and the lighting lens and the first protective body are formed integrally.

5. The improved packaging module of the optical sensor as claimed in claim 1, wherein the second protective body further packages the illuminating unit, and the second protective body defines a second aperture thereon corresponding to the illuminating unit.

6. The improved packaging module of the optical sensor as claimed in claim 5, wherein the first protective body further comprises a second light pipe set at the second aperture corresponding to the illuminating unit, and the first protective body and the second light pipe are formed integrally.

7. The improved packaging module of the optical sensor as claimed in claim 5, wherein the optical sensor module further comprises a lighting lens set at the second aperture corresponding to the illuminating unit, and the lighting lens and the first protective body are formed integrally.

8. The improved packaging module of the optical sensor as claimed in claim 1, wherein the first protective body is made of transparent material or transparent plastic.

9. The improved packaging module of the optical sensor as claimed in claim 1, wherein the first protective body is made of Epoxy or Polycarb or IR Pass material.

10. The improved packaging module of the optical sensor as claimed in claim 1, wherein the second protective body is black or is made of opaque plastic.

11. The improved packaging module of the optical sensor as claimed in claim 10, wherein the plastic is Epoxy or Polycarb.

12. The improved packaging module of the optical sensor as claimed in claim 3, wherein the imaging lens is made of Epoxy or Polycarb.

13. The improved packaging module of the optical sensor as claimed in claim 3, wherein the imaging lens is a spherical lens or a non-spherical lens.

14. The improved packaging module of the optical sensor as claimed in claim 1, wherein the illuminating unit is an illuminating source.

15. The improved packaging module of the optical sensor as claimed in claim 1, wherein the illuminating unit is a ruminant module, and the luminant module comprises an illuminating source and a lighting lens.

16. The improved packaging module of the optical sensor as claimed in claim 14, wherein the illuminating source is an incoherent illuminant or a coherent illuminant.

17. The improved packaging module of the optical sensor as claimed in claim 15, wherein the lighting lens is a spherical lens or a non-spherical lens.

18. An improved packaging module of an optical sensor, comprising:
a circuit board, and
an optical sensor module, mounted on the circuit board and comprising a linear optical sensor connected electronically with the circuit board, an illuminating unit connected electronically with the circuit board, and a second protective body packaging the linear optical sensor and the illuminating unit, a first protective body covering the linear optical sensor and the illuminating unit, the second protective body defining a first aperture thereon corresponding to the linear optical sensor and a second aperture thereon corresponding to the illuminating unit;
the linear optical sensor, the illuminating unit, the first protective body and the second protective body are combined integrally.

19. The improved packaging module of the optical sensor as claimed in claim 18, wherein a first light pipe is set at the first aperture corresponding to the linear optical sensor, and the first light pipe and the first protective body are formed integrally.

20. The improved packaging module of the optical sensor as claimed in claim 18, wherein an imaging lens is set at the first aperture corresponding to the linear optical sensor, and the imaging lens and the first protective body are formed integrally.

21. The improved packaging module of the optical sensor as claimed in claim 18, wherein a lighting lens is set at the second aperture corresponding to the illuminating unit, and the lighting lens and the first protective body are formed integrally.

22. The improved packaging module of the optical sensor as claimed in claim 18, wherein the first protective body further comprises a second light pipe set at the second aperture corresponding to the illuminating unit, the first protective body and the second light pipe are formed integrally.

23. The improved packaging module of the optical sensor as claimed in claim 18, wherein the first protective body is made of transparent material or transparent plastic, the transparent plastic is Epoxy or Polycarb or IR Pass material.

24. The improved packaging module of the optical sensor as claimed in claim 18, wherein the second protective body is black or is made of opaque plastic.

25. The improved packaging module of the optical sensor as claimed in claim 20, wherein the imaging lens is made of Epoxy or Polycarb.

26. The improved packaging module of the optical sensor as claimed in claim 20, wherein the imaging lens is a spherical lens or a non-spherical lens.

27. The improved packaging module of the optical sensor as claimed in claim 18, wherein the illuminating unit is an illuminating source.

28. The improved packaging module of the optical sensor as claimed in claim 18, wherein the illuminating unit is a luminant module, the luminant module comprises an illuminating source and a lighting lens.

29. The improved packaging module of the optical sensor as claimed in claim 27, wherein the illuminating source is an incoherent illuminant or a coherent illuminant.

30. The improved packaging module of the optical sensor as claimed in claim 28, wherein the lighting lens is a spherical lens or a non-spherical lens.
